(19) United States
(12) Patent Application Publication
(10) Pub. No.: US 2015/0268842 A1
(43) Pub. Date: Sep. 24, 2015

(54) METHOD FOR CONFIGURING DYNAMIC USER INTERFACE OF HEAD UNIT OF VEHICLE BY USING MOBILE TERMINAL, AND HEAD UNIT AND COMPUTER-READABLE RECODING MEDIA USING THE SAME

(71) Applicant: Obigo Inc., Gyeonggi-do (KR)

(72) Inventors: Sung Hwan Kim, Seoul (KR); Sang Kyu Kim, Gyeonggi-do (KR); Hee Kyong Kim, Seoul (KR)

(73) Assignee: Obigo Inc., Gyeonggi-do (KR)

(21) Appl. No.: 14/291,814

(22) Filed: May 30, 2014

(30) Foreign Application Priority Data
Mar. 18, 2014 (KR) 10-2014-0031623

(51) Int. Cl. G06F 3/0484

(52) U.S. Cl. CPC G06F 3/04847; G06F 3/04842

(57) ABSTRACT

The present invention relates to a method for configuring UI of a head unit of a vehicle by using a mobile terminal. The method includes steps of: allowing the head unit to acquire information on application stored in the mobile terminal; allowing the head unit to acquire information on comparison between a driving speed of the vehicle and a preset reference speed to decide a specific template interoperable with the acquired application; and allowing the head unit to display a running state of the acquired application through a first template if the vehicle is determined not to be driven, allowing the head unit to display the running state thereof through a second template if the driving speed thereof is less than the preset reference speed and allowing the head unit to display the running state thereof through a third template if the driving speed thereof exceeds the preset reference speed.

### CROSS REFERENCE TO RELATED APPLICATION

This application claims priority to and incorporates herein by reference all disclosure in Korean Patent Application No. 10-2014-0031623 filed Mar. 18, 2014.

### FIELD OF THE INVENTION

The present invention relates to a method, a head unit and a computer readable recording media for configuring a dynamic user interface of a head unit in a vehicle by using a mobile terminal; and more particularly, to the method, the head unit and the computer readable recording media for configuring the user interface allowing the head unit in the vehicle to acquire information on at least one application stored at an executable state in the mobile terminal if being connected therewith, and (i) allowing a running state of the acquired application to be displayed through a first template among all available templates if the vehicle is determined not to be driven (ii) allowing the running state of the acquired application to be displayed through a second template among all the available templates if the driving speed of the vehicle is determined to be less than the preset reference speed thereof, and (iii) allowing the running state of the acquired application to be displayed through a third template among all the available templates if the driving speed of the vehicle is determined to exceed the preset reference speed thereof by referring to information on the driving speed of the vehicle or information on the comparison between the driving speed of the vehicle and preset reference speed thereof.

### BACKGROUND OF THE INVENTION

As drivers of vehicles use head units of the vehicles in which a variety of applications are included while driving, traffic accident risks become higher due to their driving distraction. Due to general user interfaces of smart devices including a function of a general head unit without considering the special situation that a driver is driving, unnecessary information is excessively exposed to the driver who is driving. Thus, the traffic accident risks are increasing because the drivers cannot focus on driving.

To reduce traffic accident risks arising therefrom, the relevant laws and regulations have been amended, which are in force. In addition, some leading vehicle makers standardize information exposed on dashboards depending on driving conditions to reduce traffic accident risks by preventing gazes from being dispersed and this is the trend of the automotive industry.

Besides, some companies hold a technology of interoperating a head unit with a mobile terminal such as smart phone which uses an application by connecting the mobile terminal with the head unit, but when such a technology is implemented, a user interface in relation to device operation could be more complicated due to an environment of connecting the mobile terminal with a variety of applications to the head unit.

As mentioned above, to solve such problems, a conventional technology as shown in FIG. 3 was suggested. However, because the conventional technology was configured to display a simple screen like FIG. 3 that cautions a driver or configured to prevent a display of the head unit from working, users felt inconvenience. Thus, the dramatic reduction of the traffic accident risks is not achieved according to the conventional technology.

### SUMMARY OF THE INVENTION

It is an object of the present invention to solve all the problems mentioned above.

It is another object of the present invention to allow a driver of a vehicle to concentrate better on driving to prevent the degree of concentration of the driver from going down under the laws in force by automatically adjusting a configuration of a template by referring to information on comparison between a preset reference speed and driving speed of the vehicle.

It is still another object of the present invention to increase driving safety and reduce traffic accident risks because less information unnecessary to concentrate on driving is provided and more information necessary to do so is provided.

In accordance with one aspect of the present invention, there is provided a method for configuring a user interface of a head unit of a vehicle by using a mobile terminal, including steps of: (a) allowing the head unit of the vehicle, if being connected with by the mobile terminal, to acquire information on at least one application stored at an executable state in the mobile terminal; (b) allowing the head unit to acquire information on comparison between a driving speed of the vehicle and a preset reference speed to decide a specific template interoperable with the acquired application among multiple templates stored in the head unit by referring to the information on the acquired application; and (c) allowing the head unit to display a running state of the acquired application through a first template if the vehicle is determined not to be driven, allowing the head unit to display the running state of the acquired application through a second template if the driving speed of the vehicle is less than the preset reference speed and allowing the head unit to display the running state of the acquired application through a third template if the driving speed of the vehicle exceeds the preset reference speed.

In accordance with another aspect of the present invention, there is provided a head unit of a vehicle for configuring a user interface by using a mobile terminal, including: an application connecting part for acquiring information on at least one application stored at an executable state in the mobile terminal if the mobile terminal is connected with the head unit in the vehicle; a vehicle driving information acquiring part for acquiring information on comparison between a driving speed of the vehicle and a preset reference speed to determine a specific template interoperable with the acquired application among multiple templates stored in the head unit by referring to the information on the acquired application; and a template managing part for displaying a running state of the acquired application through a first template if the vehicle is determined not to be driven, displaying the running state of the acquired application through a second template if the driving speed of the vehicle is less than the preset reference speed and displaying the running state of the acquired application through a third template if the driving speed of the vehicle exceeds the preset reference speed.

### BRIEF DESCRIPTION OF THE DRAWINGS

The above and other objects and features of the present invention will become apparent from the following description of preferred embodiments given in conjunction with the accompanying drawings, in which:

FIG. 1 is a drawing showing a method for configuring a dynamic user interface of a head unit in a vehicle by using a mobile terminal in accordance with an example embodiment of the present invention.

FIG. 2 is a block diagram showing a configuration of the head unit in the vehicle in accordance with an example embodiment of the present invention.

FIG. 3 shows a screen by a method for configuring the user interface of the head unit in the vehicle according to a conventional technology.

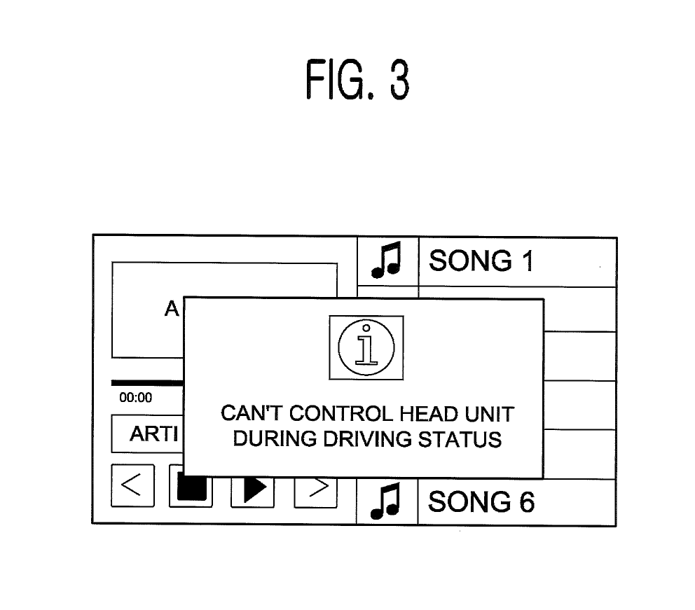

FIG. 4 illustrates a screen of the head unit changed if driving speed of the vehicle is determined to be less than a preset reference speed in accordance with an example embodiment of the present invention.

FIG. 5 shows a screen of the head unit changed if the driving speed of the vehicle is determined to exceed the preset reference speed in accordance with an example embodiment of the present invention.

FIG. 6 shows an example of operating a navigation application in accordance with an example embodiment of the present invention.

### DETAILED DESCRIPTION OF THE PREFERRED EMBODIMENTS

The detailed description of the present invention illustrates specific embodiments in which the present invention can be performed with reference to the attached drawings.

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present invention, although different, are not necessarily mutually exclusive. For example, a particular feature, structure, or characteristic described herein in connection with one embodiment may be implemented within other embodiments without departing from the spirit and scope of the present invention. In addition, it is to be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

To allow those skilled in the art to the present invention to be carried out easily, the example embodiments of the present invention by referring to attached diagrams will be explained in detail as follows:

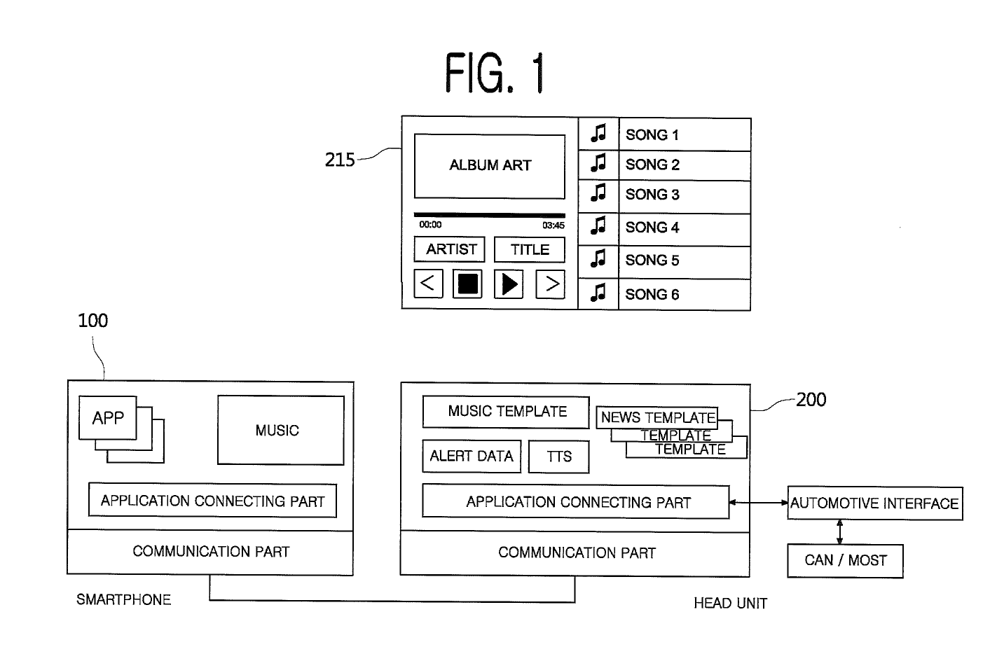

FIG. 1 shows a method for configuring a dynamic user interface of a head unit in a vehicle by using a mobile terminal in accordance with an example embodiment of the present invention.

In accordance with the present invention, the user interface may be configured to allow information on applications acquired from the mobile terminal to be applied to a template whose components can be changed by referring to information on comparison between a driving speed of the vehicle and a preset reference speed and then be displayed.

First of all, by using FIG. 1, a method for configuring the dynamic user interface of the vehicle in use of the mobile terminal is explained as follows:

As illustrated in FIG. 1, a whole system in accordance with one example embodiment of the present invention may include a mobile terminal 100 and a head unit 200.

First of all, the head unit 200 in accordance with one example embodiment of the present invention may perform a function of connecting its template 215 with at least one application executed in the mobile terminal 100, providing information inputted from the application executed in the mobile terminal 100 to a user through its template, and transmitting control information inputted by the user through its template 215 to the application executed in the mobile terminal 100 and also allowing the user to use the application executed in the mobile terminal 100 through its template 215 provided by the head unit 200.

In an environment where the mobile terminal 100 such as a smart phone or a tablet PC is connected with the head unit 200, the head unit 200 acquires information of the application stored at an executable state in the mobile terminal 100. At the time, the application may be a navigator using GPS information, an MP3 player with a list using music information, and other various categories of applications, but in the present invention, mainly music or navigation-related applications will be explained as examples for convenience of explanation.

Next, the head unit 200 may decide a suitable template interoperable with the application. At the time, it may use acquired information on comparison between the driving speed of the vehicle and the already set reference speed to decide the suitable template. The information relating to the driving speed of the vehicle may be acquired through an automotive interface module interoperated with the head unit 200 or by receiving a signal transmitted from a media oriented systems transport (MOST) or a controller area network (CAN) as an in-vehicle communication network and converting it to a signal in a format recognizable by the head unit 200.

If the vehicle is determined not to be driven, a running state of the application is allowed to be displayed through a first template provided by the head unit 200. Further, if the driving speed of the vehicle is determined to be less than the preset reference speed by using the acquired information on the comparison, the running state of the application is allowed to be displayed through a second template provided by the head unit 200. Furthermore, if the driving speed of the vehicle is determined to exceed the preset reference speed by using the acquired information on the comparison, the running state of the application is allowed to be displayed through a third template provided by the head unit 200. Herein, the second template is designed to lead the driver to concentrate on driving by being configured to include some of components of the first template and thus exposing only a small amount of information and the third template is designed to lead the drive to concentrate intensely on driving by being configured to include some of components of the second template and thus exposing only an extremely small amount of information. For this, the head unit 200 could classify and manage components included in the template corresponding to the application by range of driving speed of the vehicle. In the explanation above, the driving speed was divided into two: low and high speed but it is not limited only to these. It is sure that the range of the driving speed of the vehicle could be divided into three or more, to which templates could correspond.

By reference, even if the vehicle is determined to be backed up which is at a low speed in general, the running state of the application could be allowed to be displayed through the second template.

If it is displayed through the third template, only an extremely small amount of information is provided for the user and the user is prevented from inputting. As an expedient to relieve the user from the inconvenience, certain information relating to the acquired application may be supported to be delivered to the user of the vehicle by using an audio guidance method. For example, visual information obtained from the screen of the head unit during driving is converted into auditory information to allow the driver to concentrate better on driving.

The preset reference speed may be adjusted under the relevant laws and regulations, according to which the offered effects could be adjusted as well. Besides, the preset reference speed may be changed depending on types of applications. In a specific case, if the application is a navigator, it could be possible to set the preset reference speed to 0 to run the navigator on a safety mode automatically and to prevent any touch input by the user on the screen when the vehicle starts to be in operation.

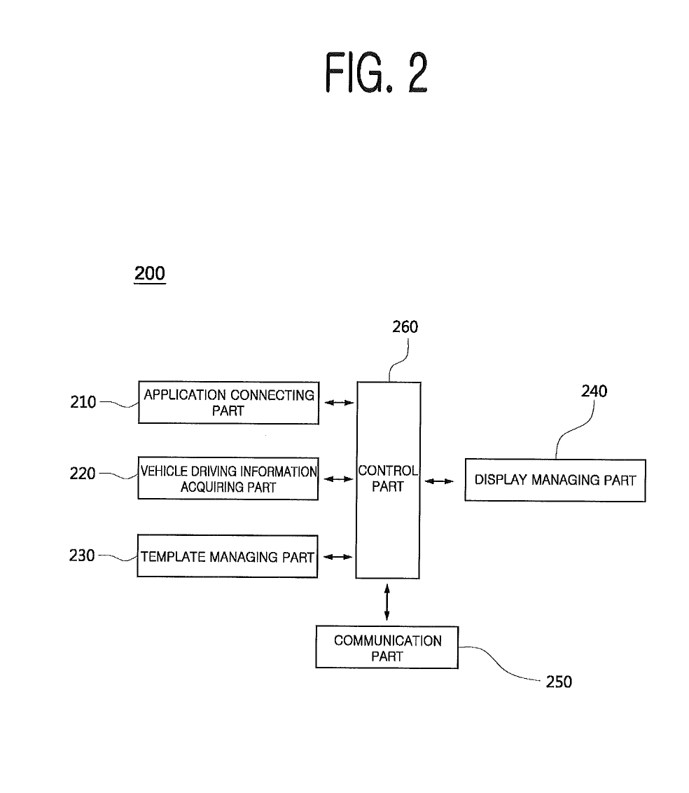

FIG. 2 is a block diagram showing an internal configuration of the head unit in the vehicle in accordance with an example embodiment of the present invention.

By referring to FIG. 2, the head unit 200 in accordance with one example embodiment of the present invention may include an application connecting part 210, a vehicle driving information acquiring part 220, a template managing part 230, a display managing part 240, a communication part 250 and a the control part 260. In accordance with one example embodiment of the present invention, at least some of the application connecting part 210, the vehicle driving information acquiring part 220, the template managing part 230, the display managing part 240, the communication part 250 and the control part 260 may be program modules communicating with the head unit 200. Such program modules may be included in the head unit 200 in a form of an operating system, an application program module, and other program modules or physically stored in various storage devices well known to those skilled in the art. In addition, they may be stored in a remote storage device capable of communicating with the head unit 200. The program modules may include but not be subject to a routine, a subroutine, a program, an object, a component, and a data structure for executing a specific operation or a type of specific abstract data that will be described in accordance with the present invention.

First, the application connecting part 210 in accordance with one example embodiment of the present invention may acquire information on at least one application stored at the executable state in the mobile terminal under the environment where the mobile terminal is connected with the head unit.

Specifically, the application connecting part 210 in accordance with one example embodiment of the present invention may perform a function of supporting the template 215 of the head unit 100 and the application of the mobile terminal 100 to be interoperated with each other by connecting them with each other.

More specifically, the application connecting part 210 in accordance with one example embodiment of the present invention may perform a function of allowing the information on events or contents occurring from the application of the mobile terminal 100 to be delivered to the template 215 of the head unit 200 and allowing the information on events or control occurring through the template 215 of the head unit 200 to be delivered to the application of the mobile terminal 100. Thus, the template 215 of the head unit 200 and the application of the mobile terminal 100 may share software library required to interoperate with each other.

Next, the vehicle driving information acquiring part 220 may acquire information on comparison between the driving speed of the vehicle and the preset reference speed thereof to determine a specific template interoperable with the acquired application among multiple templates stored in the head unit 200. Of course, as mentioned above, the reference speeds may be one, two or more and if the reference speeds are two or more, a range to which the current driving speed belongs could be acquired by comparing the current driving speed with respective reference speeds.

Let it supposed that the running state of the acquired application is allowed to be displayed through a first template provided by the head unit 200 if the vehicle is determined not to be driven by the vehicle driving information acquiring part 220.

At the time, if the driving speed of the vehicle is determined to be less than the preset reference speed by the vehicle driving information acquiring part 220, the template managing part 230 may allow the running state of the acquired application to be displayed through a second template provided by the head unit and if the driving speed of the vehicle is determined to exceed the preset reference speed by the vehicle driving information acquiring part 220, the template managing part 230 may allow the running state of the acquired application to be displayed through a third template provided by the head unit.

Next, if a suitable template among all the templates is determined to display the running state of the acquired application therethrough by the template managing part 230, the display managing part 240 could display the state of the acquired application being executed through the template.

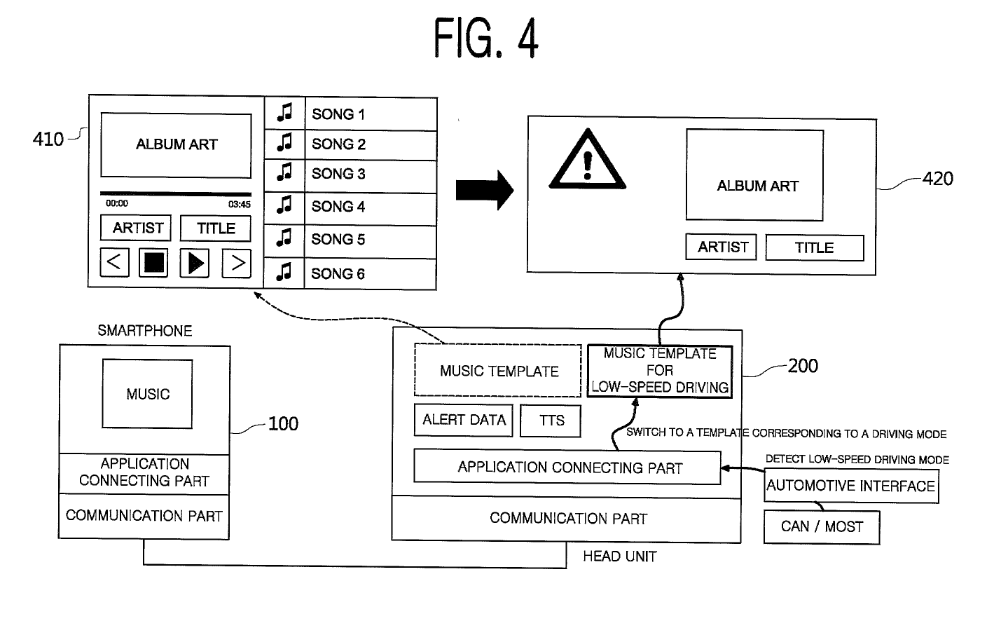

FIG. 4 illustrates a screen of the head unit changed if the driving speed of the vehicle is determined to be less than preset reference speed in accordance with an example embodiment of the present invention. It could be found that the components of a screen 420 of the head unit displayed through the second template on which the running state of the application is displayed are reduced compared to those of a screen 410 of the head unit displayed through the first template.

More specifically, in case of the first template, it could be found that a list of songs to be replayed is displayed to be selectable and information on albums, artists, and songs is also displayed and user interface with buttons such as play and stop is provided. In contrast, in case of the second template, the components of the user interface thereof are reduced so that information such as the name of a song that is now replayed is provided only within the range of the driver not disturbing driving.

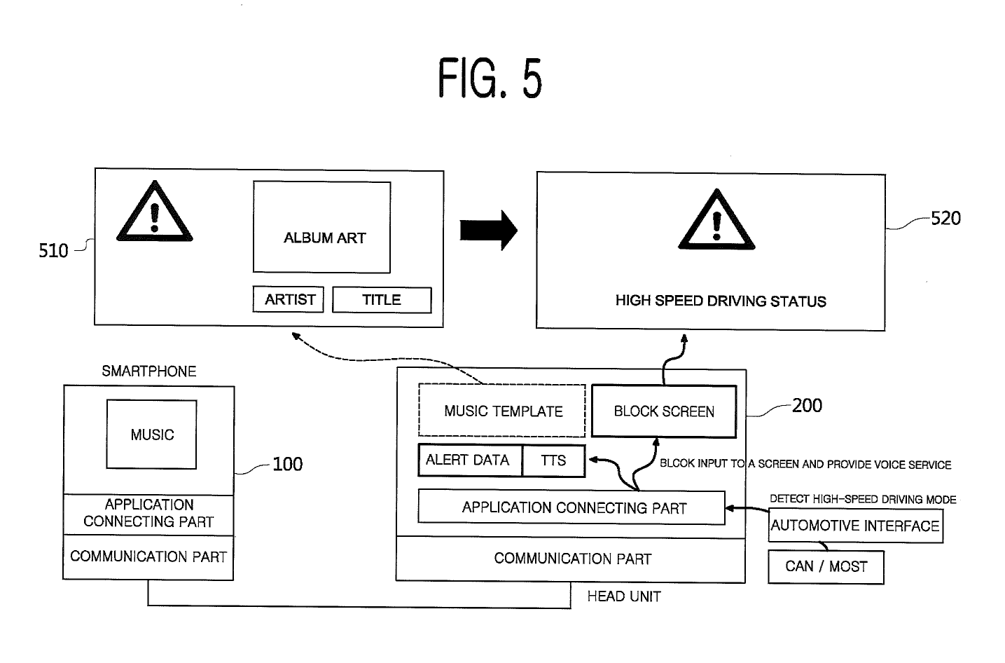

FIG. 5 shows a screen of the head unit changed if the driving speed of the vehicle is determined to exceed the preset reference speed in accordance with an example embodiment of the present invention. It could be found that the components of a screen 520 of the head unit where the running state of the application is displayed through the third template were reduced compared to those of a screen of the head unit 510 displayed through the second template.

More specifically, if the speed is determined to exceed the preset reference speed, it could be changed to provide only minimum information on the running state of the application, etc. by reducing most components of the template to allow the driver to concentrate more intensely on driving and relevant information, etc. may be also provided by a voice guidance system to minimize the inconvenience of the driver. By referring to FIG. 5, it could be found that the application connecting part 210 sends a control signal to TTS to provide a voice service and the input is limited since the control signal is entered to a “block screen”.

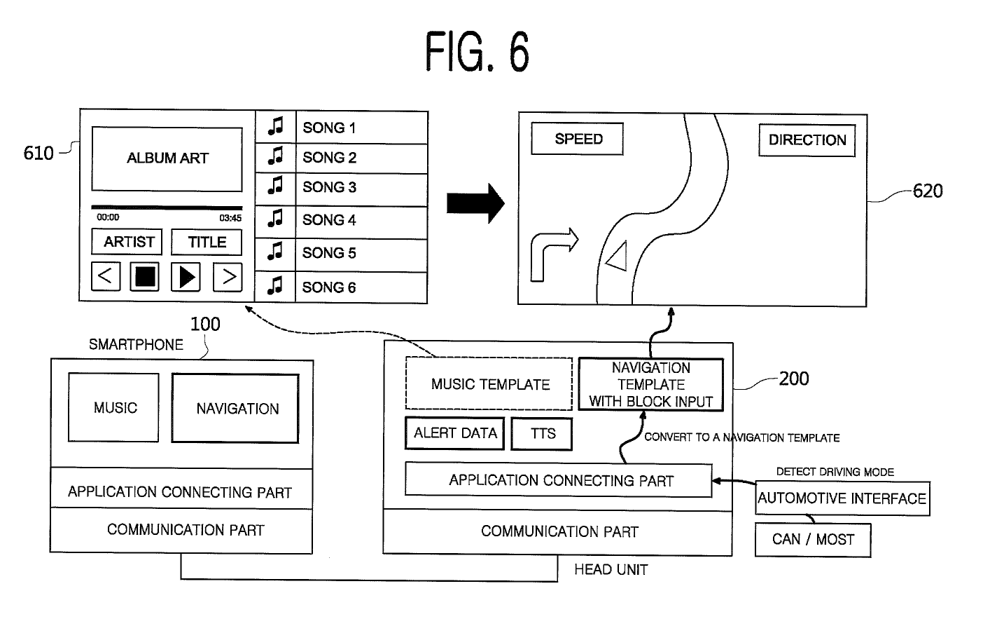

FIG. 6 shows a screen of the head unit in the vehicle changed by the method for configuring the dynamic user interface of the head unit by using the mobile terminal in accordance with an example embodiment of the present invention. If there is a navigation application among at least one application in the mobile terminal 100, the navigation application could be automatically run in a safety mode. By referring to FIG. 6, it could be found that a music template in the head unit 200 is deactivated (as indicated in dotted line) and a navigation template is automatically activated (as indicated in a solid line). To prevent the manipulation during driving, it also could be found that the input of the user was blocked through the navigation template.

In accordance with one example embodiment of the present invention, the communication part 250 performs a function of allowing the head unit 200 to be communicable with an external device such as the mobile terminal 100.

Finally, the control part 260 in accordance with one example embodiment of the present invention performs a function of controlling data flow among the template-application connecting part 210, the vehicle driving information acquiring part 220, the template managing part 230, the display managing part 240, and the communication part 250. In other words, the control part 260 controls the flow of data from/to outside or between the component of the head unit 200, the application connecting part 210, the vehicle driving information acquiring part 220, the template managing part 230, the display managing part 240, and the communication part 250 to allow each part to perform its unique functions.

In accordance with the present invention, the components of a specific template, which is interoperated with the application acquired from the mobile terminal, among templates stored in the head unit could be automatically adjusted by referring to information on comparison between the driving speed of the vehicle and the preset reference speed and information on the application acquired from the mobile terminal.

The present invention allows the driver of the vehicle to concentrate on driving depending on the driving speed of the vehicle and this may cause the safety of the vehicle to be improved because the user could drive the vehicle more safely by receiving less information unnecessary for driving and more information necessary therefore.

The embodiments of the present invention as explained above can be implemented in a form of executable program command through a variety of computer means recordable to computer readable media. The computer readable media may include solely or in combination, program commands, data files, and data structures. The program commands recorded to the media may be components specially designed for the present invention or may be usable to a skilled person in a field of computer software. Computer readable record media include magnetic media such as hard disk, floppy disk, and magnetic tape, optical media such as CD-ROM and DVD, magneto-optical media such as floptical disk and hardware devices such as ROM, RAM, and flash memory specially designed to store and carry out programs. Program commands include not only a machine language code made by a complier but also a high level code that can be used by an interpreter etc., which is executed by a computer. The aforementioned hardware device can work as more than a software module to perform the action of the present invention and they can do the same in the opposite case.

As seen above, the present invention has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present invention must not be confined to the explained embodiments, and the following patent claims as well as everything including variations equal or equivalent to the patent claims pertain to the category of the thought of the present invention.

What is claimed is:

1. A method for configuring a user interface of a head unit of a vehicle by using a mobile terminal, comprising steps of:
(a) allowing the head unit of the vehicle, if being connected with by the mobile terminal, to acquire information on at least one application stored at an executable state in the mobile terminal;
(b) allowing the head unit to acquire information on comparison between a driving speed of the vehicle and a preset reference speed to decide a specific template interoperable with the acquired application among multiple templates stored in the head unit by referring to the information on the acquired application; and
(c) allowing the head unit to display a running state of the acquired application through a first template if the vehicle is determined not to be driven, allowing the head unit to display the running state of the acquired application through a second template if the driving speed of the vehicle is less than the preset reference speed and allowing the head unit to display the running state of the acquired application through a third template if the driving speed of the vehicle exceeds the preset reference speed.

2. The method of claim 1, wherein the head unit classifies and manages components included in at least one template corresponding to the acquired application by range of the driving speed of the vehicle and wherein the second template is configured with some of components of the first template and the third template is configured with some of components of the second template.

3. The method of claim 1, wherein the head unit acquires information on the driving speed of the vehicle through an automotive interface module interoperated therewith, which performs a function of receiving a signal transmitted from a media oriented system transport or a controller area network as an in-vehicle communication network and a function of converting the signal to the other in a form recognizable by the head unit.

4. The method of claim 1, wherein the head unit allows the running state of the acquired application to be displayed through the second template, if the vehicle is determined to be backed up.

5. The method of claim 1, wherein the third template is set to prevent an input of a user of the vehicle.

6. The method of claim 1, wherein, if the running state of the acquired application is allowed to be displayed through the third template, the head unit supports certain information relating to the acquired application to be delivered to the user of the vehicle by a voice guidance system.

7. A head unit of a vehicle, for configuring a user interface by using a mobile terminal, comprising:
an application connecting part for acquiring information on at least one application stored at an executable state in the mobile terminal if the mobile terminal is connected with the head unit in the vehicle;
a vehicle driving information acquiring part for acquiring information on comparison between a driving speed of the vehicle and a preset reference speed to determine a specific template interoperable with the acquired application among multiple templates stored in the head unit by referring to the information on the acquired application; and
a template managing part for displaying a running state of the acquired application through a first template if the vehicle is determined not to be driven, displaying the running state of the acquired application through a second template if the driving speed of the vehicle is less than the preset reference speed and displaying the running state of the acquired application through a third template if the driving speed of the vehicle exceeds the preset reference speed.

8. The head unit of claim 7, wherein the template managing part classifies and manages components included in at least one template corresponding to the acquired application by range of the driving speed of the vehicle and wherein the second template is configured with some of components of the first template and the third template is configured with some of components of the second template.

9. The head unit of claim 7, wherein the vehicle driving information acquiring part acquires information on the driving speed of the vehicle through an automotive interface module interoperated therewith, which performs a function of receiving a signal transmitted from a media oriented system transport or a controller area network as an in-vehicle communication network and a function of converting the signal to the other in a form recognizable by the head unit.

10. The head unit of claim 7, wherein the template managing part allows the running state of the acquired application to be displayed through the second template, if the vehicle is determined to be backed up.

11. The head unit of claim 7, wherein the template managing part sets the third template to prevent an input of a user of the vehicle.

12. The head unit of claim 7, wherein, if the running state of the application is allowed to be displayed through the third template, the template managing part supports certain information relating to the acquired application to be delivered to the user of the vehicle by a voice guidance system.

13. One or more computer-readable recording media having stored thereon a computer program that, when executed by one or more processors, causes the one or more processors to perform acts including:
(a) allowing the head unit of the vehicle, if being connected with by the mobile terminal, to acquire information on at least one application stored at an executable state in the mobile terminal;
(b) allowing the head unit to acquire information on comparison between a driving speed of the vehicle and a preset reference speed to decide a specific template interoperable with the acquired application among multiple templates stored in the head unit by referring to the information on the acquired application; and
(c) allowing the head unit to display a running state of the acquired application through a first template if the vehicle is determined not to be driven, allowing the head unit to display the running state of the acquired application through a second template if the driving speed of the vehicle is less than the preset reference speed and allowing the head unit to display the running state of the acquired application through a third template if the driving speed of the vehicle exceeds the preset reference speed.
